(19) United States
(12) Patent Application Publication
(10) Pub. No.: US 2004/0200369 A1
(43) Pub. Date: Oct. 14, 2004

(54) Method and system for printing press image distortion compensation

(76) Inventor: Thomas P. Brady, Methuen, MA (US)

Correspondence Address: Agfa Corporation, Law & Patent Department, 200 Ballardvale Street, Wilmington, MA, 01887-1069, US

(21) Appl. No.: 10/411,770

(22) Filed: Apr. 11, 2003

(51) Int. Cl. B41C 1/00

(52) U.S. Cl. 101/463.1; 101/484

(57) ABSTRACT

A system for exposing offset printing media with image data, which have been scaled to compensate for web growth, comprises an imaging engine for exposing the offset printing media in response to scaled image data and a print drive system that receives plate-level image data and generates the scaled image data to the imaging engine in response to web growth information. This system is distinguished from other systems that scale the source images, typically prior to halftoning. Instead, the scaling is performed to the plate-level image data, before it is feed to the imaging engine.

### BACKGROUND OF THE INVENTION

In offset printing with a web printing press, a paper web travels through multiple printing press units. Each unit sequentially applies different image separations or color planes to the paper web. For example in a common a four-color printing process, the inks cyan, magenta, yellow, and black are added by successive printing press units to build the color spectrum on the web.

The application of ink and fountain solution coupled with the action of the printing press often change the dimensions of the paper web. One factor contributing to such growth is exposure of the paper to liquids. As the paper receives each application of ink and fountain solution, the paper expands resulting in an overall increase in size. Further, the squeezing of the paper by the rollers of the press units and the tension applied to the web as it is pulled along contribute further to dimensional changes. Usually, the first ink applied gives rise to the most growth, with the amount of growth decreasing with subsequent inks. Often, there is little or no observable growth with the final ink printed.

However, under other conditions, the paper web may actually undergo shrinkage. Sometimes press operators locate dryers or fans between printing units to dry the ink. This can cause the web to actually contract.

This distortion, often referred to as “web growth” or “fan out”, is also dependent on other factors such as the type of print media. Typically, growth is more prevalent on porous media, e.g., newsprint, than it is on coated stock. Other variables that can contribute to the dimensional changes are temperature, humidity, and ink coverage. These factors can change from job to job and even during a press run of a single job.

Because growth alters the original dimensions of the paper, absent intervention, the images of the color planes will not align correctly. This misalignment of the color planes is referred to as misregistration. The misregistered colors undesirably reduce image reproduction quality due to the resulting image distortion.

To correct for gross misregistration of images, printing presses must frequently be stopped during the printing process and realigned. This method, however, only addresses alignment between plates, which may contain multiple pages. The relative amount of growth is small, usually less than 1.0%. But, on a 40-inch (˜100 centimeter (cm)) wide/high image, containing multiple pages, the growth would be 0.4 inches or about 1 cm, which is noticeable.

Misregistration can be further minimized if the location of the pages on the plate is adjusted at the imposition step on a plate-to-plate basis. Page positions on successive plates for each color are adjusted so that the centers of the pages are registered with respect to each other in the successive color planes. Thus, the distortions are limited by the dimensions of the pages. Thus, in an 8 inch by 10 inch (about 20 cm by 25 cm) page with 1% distortion, a misregistration of only about 0.04 by 0.05 inches or about 1 millimeter (mm) arises along its edges. The registering of the centers of the color images will distribute the distortion from the centers to the edges of the printed area, but even small misalignments are noticeable.

Another solution to color misregistration arising from web growth can be applied earlier in the printing pipeline. Prior to imposition, the original source images are “RIPped”. This involves the operation of a raster image processor that converts the source contone images into the halftone image data of the separate color planes by application of halftone masks or error diffusion processes, for example. At this stage, different scale factors are applied to each color to compensate for the expected distortion during the printing process using knowledge of the target web and the printing press.

### SUMMARY OF THE INVENTION

Nonetheless, each of these solutions has drawbacks. Aligning the page-level images on the plates during the imposition step to account for web growth, brings the pages into close, but not perfect registration. Misregistration still occurs toward the outer edges of the pages due to the web growth. Scaling the images as part of the raster image processing can address web growth even at the granularity of the page. Some have even proposed anamorphic scaling to address the different levels of web growth, both in the direction of the web and across the width of the web. The problem, however, is that at this early stage in the printing pipeline, information concerning the target printing press and media might not be known, preventing selection of length and width scaling factors. Moreover, later in the printing process proofing is often performed where these color planes are digitally recombined in order to confirm the layout. This scaling in the RIPping process makes this subsequent proofing difficult, since the images must now be descaled to enable this digital proofing process to proceed.

In general, according to one aspect, the invention features a system for exposing offset printing media with image data that have to be scaled to compensate for web growth. The system comprises an imaging engine for exposing the offset printing media in response to scaled image data and a print drive system that receives plate-level image data and generates the scaled image data to the imaging engine in response to web growth information.

This system is distinguished from other systems that scale the source images, typically prior to halftoning. Instead, the scaling is performed to the plate-level image data, before it is feed to the imaging engine, thereby avoiding the previously described problems.

In one embodiment, the offset printing media are films that are used to make printing plates for a web printing press. In another example, the offset print media are printing plates. In still another embodiment, the offset printing media are the rollers of the printing press. That is, in computer-to-press” systems, in contrast to CTF (film) or CTP (plate) systems, imaging heads are mounted on the press to create the flat-image on the rollers of the press. Typically, a microwave sensitive emulsion is sprayed onto the rollers, or a wrapper on the rollers, and exposed by the imaging head to transfer the image directly to the press.

In the current embodiment, an imposition system is used to generate the plate-level image data by combining page-level image data of several pages. A raster image processor halftones page-level images into the page-level image data for each color plane.

The present system preferably scales on the fly. That is, the print drive system generates the scaled image data during a transfer of the scaled image data to the imaging engine. Thus, it is not necessary to store all of the scaled data and the system also operates more quickly since the scaling is performed during the transfer.

The print drive system generates the scaled image data by adding pixels to and/or removing pixels from the plate-level image data. The added or removed pixels are preferably stochastically distributed between rows and/or columns.

In general according to another aspect, the invention also features a method for exposing offset printing media with image data that have to be scaled to compensate for web growth. This method comprises generating the scaled image data to the imaging engine in response to web growth information and plate-level image data and exposing the offset printing media in response to scaled image data.

The invention also features a web printed image. It comprises areas corresponding to page-level image data and indicia for assessing web growth. As a result, web growth or distortion can be measured during production jobs. This allows for the on-going characterization of the distortion created by a given press and the web media combination.

In general, according to still another aspect, the invention features a method for compensating for web growth. This method comprises characterizing web growth by measuring web growth at multiple places on a web and compensating for the web growth by scaling plate-level image data in response to the measured web growth. Thus, web growth is not simply measured at the page image level but at multiple places across a page, for example.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of an offset web press system according to the present invention;

FIG. 2 is a flow diagram illustrating the process for distortion characterization, according to the present invention;

FIGS. 3A and 3B are wide and a close-up plan views, respectively, of a printed test image used for web growth characterization;

FIG. 4 is a schematic view showing measurements used to build the web growth information database according the invention;

FIG. 5 is a flow diagram illustrating the printing process for the web, using the web growth information, according to the present invention;

FIG. 6 is a flow diagram illustrating the process for scaling the plate-level image data according to the preferred embodiment; and

FIG. 7 is a schematic diagram of scaling mask for identifying pixels to be deleted or duplicated.

### DETAILED DESCRIPTION OF THE PREFERRED EMBODIMENTS

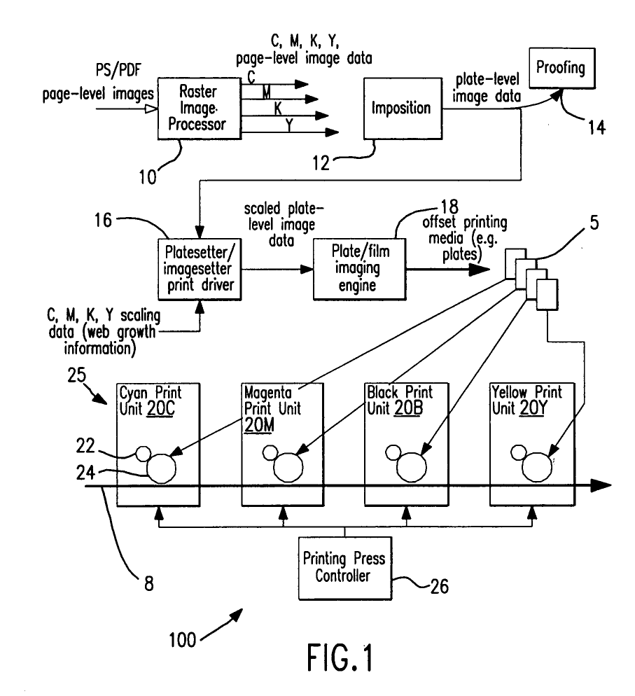

FIG. 1 shows an offset web press system 100 that has been constructed according to the principles of the present invention.

In the common implementation, the input source file is a Postscript file or portable document file (.pdf). This typically comprises contone images of the pages to be printed on the paper web 8.

A raster image processor (RIP) 10 is then used to convert, or RIP, the source file(s) into a format appropriate for offset printing. That is, the page-level images are halftoned by the raster image processor 10 to thereby generate four data sets of page-level halftone image data. Each data set represents a different color plane or separation that is used in the production of a plate or roller 5 for one of printing units 20C, 20M, 20B, and 20Y.

Digital halftoning involves conversion of the contone images and text to a binary, or halftone, representation. Color tone values of the contone image elements become binary dot patterns that, when averaged, appear to the observer as the desired color tone value. The greater the coverage provided by the dot pattern, the darker the color tone value.

A number of techniques exist for determining how to arrange the halftone dots in the process of transforming the contone image into a halftone image. The two most common techniques are error diffusion and threshold masks.

In error diffusion halftoning, a decision whether to print a dot of ink or toner is made at each pixel of a screen based on the value of the underlying contone image elements. An error necessarily results, because of the inability of the printing process to render any, or a limited number of, intermediate tones. This error is carried over into the decision process of an adjacent pixel. Error generated here is used in another pixel decision process, and so on.

A more common approach to creating digital halftones uses a threshold mask to simulate the classical optical approach. This mask is an array of thresholds that spatially correspond to the addressable points on the output medium. At each location, an input value from the contone image is compared to a threshold to make the decision whether to print a dot or not. A small mask (tile) can be used on a large image by applying it periodically.

Thus, the “RIPping” process yields a set of color planes. In the specific example, these are cyan, magenta, black, and yellow page-level raster image data. This is the one bit image data for the half-tone image.

Next, an imposition system 12 is used to locate this page-level halftone image data of multiple pages but from the same color plane on common plates. These plates can be large, such as 40 inches (100 cm) in length and 20 inches (50 cm) in width. As a result, six or eight pages are sometimes laid out onto each plate.

At this stage, digital proofing system 14 is often used to confirm the layout and that the RIPping process has yielded an acceptable halftone conversion. This proofing involves the digital reconstitution of the images from the various color planes to ensure that the images have the proper layout and color balance.

According to the present invention, since the different color planes are preferably not scaled yet to account for web growth, the proofing process can be implemented as in the typical case. No descaling is required, for example.

These plate-level image data are also received by a platesetter or imagesetter print driver 16, or in the case of a computer-to-press system, the imaging system for the rollers. This device or computer feeds the data to the plate, film, or roller imaging engine 18. Its challenge is to buffer the data so that they can be provided at the rate at which the data are consumed by the high speed imaging engine 18. In one typical system, the imagine engine 18 consumes the plate-level image data at a rate of 16 Megabytes per second.

According to an aspect of the invention, the print drive system 16 scales the plate-level image data that were generated by the imposition system 12 to compensate for the expected web growth that will take place in the printing press 25. Specifically, the web growth information is specified in terms of its direction. In the present invention, it is measured from the center of each page, moving outward. The directions are described as Easterly, Westerly, Northerly, and Southerly, for each color plane. This is because each of these separate color planes will exhibit different amounts of distortion relative to a reference color plane.

The imaging engine 18 exposes the printing media. In one example, the printing media are plates as in a computer-to-plate system. In other examples, the printing media are film. In The film is then used to manufacture the printing plates. In still other examples, the printing media is the rollers as in a computer-to-press system.

The resulting rollers or plates 5, which were either directly exposed in the imaging engine 18 or produced from the film exposed in the imaging engine 18, are then used in the web printing press 25. Specifically, the cyan plate is loaded into a cyan print unit 20C of the press 25, the magenta plate is loaded into a magenta print unit 20M, the black printing plate is loaded into the black print unit 20B, and the plate for the yellow color plane is loaded into the yellow print unit 20Y. The web 5 then successively passes through each of these print units 20C, 20M, 20B, and 20Y, each printing unit applying its color to thereby create a full spectrum image on the web 8.

Specifically, the plates 5 are secured to printing drums 24, in each of the print units 20C, 20M, 20B, and 20Y. These drums rotate to successively print the media of the plates 5 onto the web 8. An inking roller 22 is used to apply the ink to the plates on the drum 24 to thereby create the image. The press 100 is operated under the control of printing press controller 26.

1. Distortion Characterization

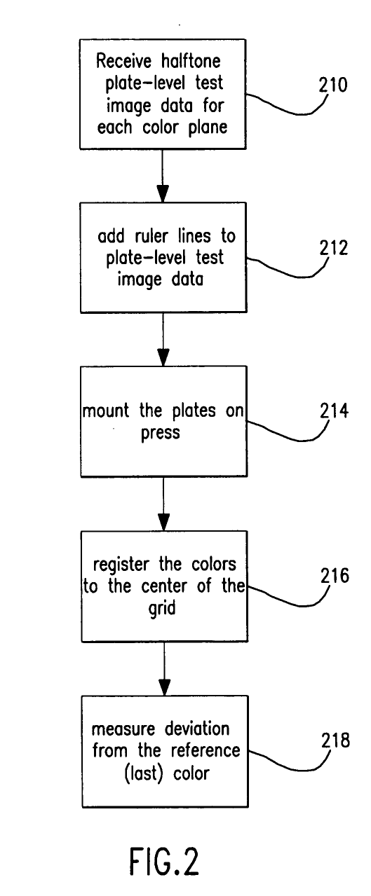

FIG. 2 shows the process for distortion characterization of the present invention, the distortion characterization being used to build the web growth information provided to the print driver 16.

Specifically, in step 210, print driver 16 receives half-tone plate-level test image data for each of the color planes. In an example of a four-colorjob (CMYK), an assumption is made concerning the percentage of ink coverage. Generally, the ink coverage for each of the separate inks is selected to be similar to that of the anticipated job. For the purposes of the present example, the target plate dimensions are 30 inches (75 cm) high from top to bottom and 40 inches (100 cm) wide from left to right. However, the present invention can be applied to other primary color schemes and a different order of ink application or job dimensions.

Next, in step 212, ruler lines are added to the plate level test image data. In one implementation, the operator selects whether metric or inch rulers are used. This is done for each of the color planes. The plates are then fabricated, either directly or using intermediate film. Or, the rollers are directly imaged.

Then, in step 214, the test image plates 5 are mounted on the corresponding drums 24 of the print units 20C, 20M, 20B, 20Y of the printing press 25, if required. Typically, printing presses allow the plates in successive printing units 20C, 20M, 20B, and 20Y to be registered with respect to each other within a limited degree of adjustment. Specifically, the plates 5 are mounted on the printing press units and registered to each other to the centers of the grid in step 216. A test web is then printed using the plates 5.

In step 218, the deviation between the grids of the various color planes is then measured from the printed web in order to characterize the web distortion.

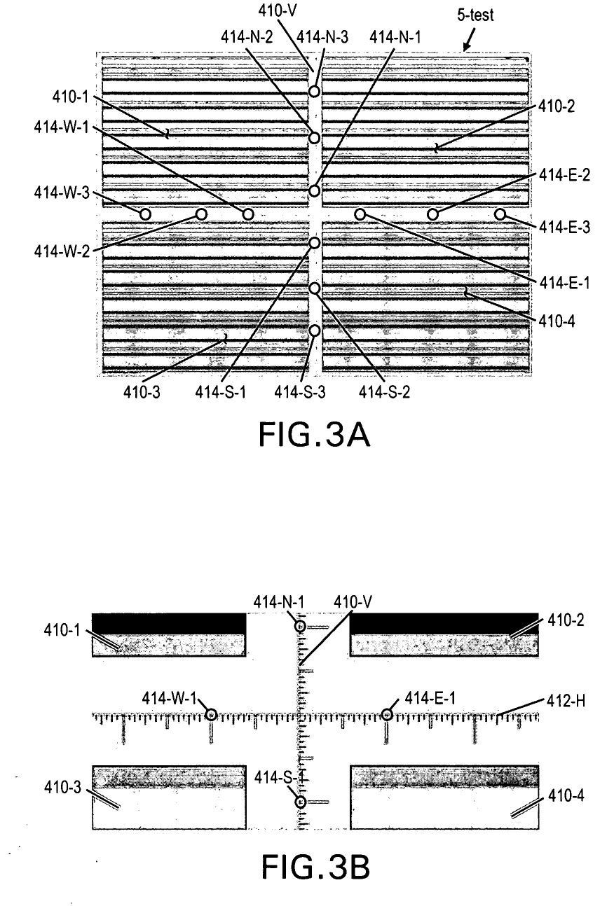

FIGS. 3A and 3B show an exemplary test image 5-test that is printed on the web according to the process of FIG. 2. Specifically, test image 5-test includes several page regions 410-1, 410-2, 410-3, 410-4. The ink density applied to the page regions is selected to correspond to that of the images to the printed. A grid is added by the print driver 16 to the otherwise blank areas between the page regions 410-1, 410-2, 410-3, 410-4. The grid includes a vertical axis 410-V and a horizontal axis 412-H of the grid, which is printed between each of the page regions 410-1, 410-2, 410-3, 410-4.

The critical characteristic of the grid 410-V, 412-H is that both the vertical axis 410-V and horizontal axis 412-H are present and printed in each of the color planes (C, M, K, Y). This enables an operator to measure the distortion between each of the color planes from the printed test image 5-test on the web 8.

FIG. 3B is a close up of the grid 410-V, 412-H. Specifically, it shows the ruler markings for both of the vertical portion 410-V and the horizontal portion 412-H.

Referring back to FIG. 3A, measurements are made from the printed grid for each of the color planes. Specifically, for each of the vertical portion 410-V and the horizontal portion 412-H of the grid, ruler marks will exhibit distortion between the color planes due to web growth in the uncompensated test image. The operator or image recognition system refers to the ruler marks or ticks at predetermined measurement positions, such as three equally spaced distances from the grid origin. These position are defined for each of the legs of the grid, such as positions, 414-N-1, 414-N-2, 414-N-3, for the northerly extending leg of the grid, positions 414-S-1, 414-S-2, 414-S-3 for the southerly extending leg of the grid, 414-E-1, 414-E-2, 414-E-3, for the easterly extending leg of the grid, and finally 414-W-1, 414-W-2, 414-W-3, for the westerly extending leg of the grid.

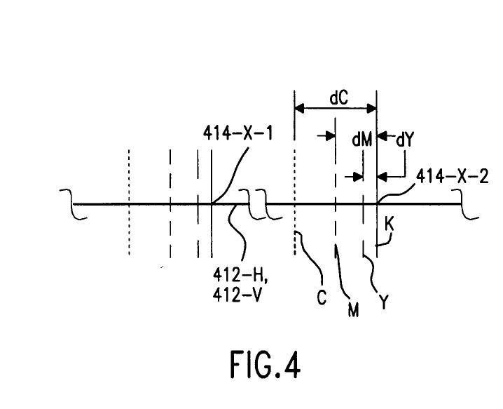

With reference to FIG. 4, at each of the measurement positions 414, web distortion is characterized. For example at exemplary position 414-X-2, there is a ruler tick for black or K, a corresponding ruler tick for yellow or Y, a ruler tick for magenta or M, and a ruler tick for cyan or C. In the given example, the black is used as the reference color. From this, the distances dY, dM, and dC are measured. These are distances between the corresponding ticks for each of the other colors, cyan, magenta, and yellow.

From this information a database is created as illustrated in Table 1 below. This database holds the distortion measurements at each position 414 at each distance from the origin for each of the directions.

TABLE 1
(Web Growth Information Database)

| | Cyan | Magenta | Black | Yellow |
|---|---|---|---|---|
| Easterly | dC at 414-1-E | dM at 414-1-E | dK at 414-1-E | dY at 414-1-E |
| distortion | dC at 414-2-E | dM at 414-2-E | dK at 414-2-E | dY at 414-2-E |
| | dC at 414-3-E | dM at 414-3-E | dK at 414-3-E | dY at 414-3-E |
| Westerly | dC at 414-1-W | dM at 414-1-W | dK at 414-1-W | dY at 414-1-W |
| distortion | dC at 414-2-W | dM at 414-2-W | dK at 414-2-W | dY at 414-2-W |
| | dC at 414-3-W | dM at 414-3-W | dK at 414-3-W | dY at 414-3-W |
| Northern | dC at 414-1-N | dM at 414-1-N | dK at 414-1-N | dY at 414-1-N |
| distortion | dC at 414-2-N | dM at 414-2-N | dK at 414-2-N | dY at 414-2-N |
| | dC at 414-3-N | dM at 414-3-N | dK at 414-3-N | dY at 414-3-N |
| Southern | dC at 414-1-S | dM at 414-1-S | dK at 414-1-S | dY at 414-1-S |
| distortion | dC at 414-2-S | dM at 414-2-S | dK at 414-2-S | dY at 414-2-S |
| | dC at 414-3-S | dM at 414-3-S | dK at 414-3-S | dY at 414-3-S |

The horizontal axis of the distortion database identifies the color being described. The vertical axis of the web grow information database refers to distortion in each of the directions from the grid origin. Growth is characterized from the center of the image to each edge of the image and is typically measured in inches or metric (millimeters).

In the present embodiment, a positive growth value means the color grid tick is farther from the center than the corresponding tick of the reference color (the image has increased in size). A negative value means the color's tick is closer to the center than the corresponding tick of the reference color (the image has decreased in size).

It is not necessary to specify colors that have no measured distortion. This is typically the case for the reference color, which here is black.

TABLE 2
(Printing Press/Media Database)

| | Type 1 web | Type 2 web | Type 3 web | |
|---|---|---|---|---|
| | media | media (coated | media (heavy | Type 4 web |
| | (newsprint) | stock) | weight stock) | media |
| Printing | web growth | web growth | web growth | web growth |
| press 1 | information | information | information | information |
| | (database) 1, | (database) 1, 2 | (database) 1, 3 | (database) 1, 4 |
| | 1 | | | |
| Printing | web growth | web growth | web growth | web growth |
| press 2 | information | information | information | information |
| | (database) 2, | (database) 2, 2 | (database) 2, 3 | (database) 2, 4 |
| | 1 | | | |
| Printing | web growth | web growth | web growth | web growth |
| press 3 | information | information | information | information |
| | (database) 3, | (database) 3, 2 | (database) 3, 3 | (database) 3, 4 |
| | 1 | | | |

As discussed previously, the amount of web distortion is a function of the particular printing press on which the web was printed and the web stock that was used. In the preferred embodiment, database of web growth information for various printing presses and web media is maintained. Each location in this database has web growth information as described relative to Table 1. For example, printing press 1, with a type 1 web media, such as newsprint, has a corresponding Table 1 type database, web growth information 1,1. It is provided to thereby fully characterize the web growth that will occur for this particular web media on this particular printing press. In this way, web growth information is further specified, based upon the particular target print device and target web media to ensure that web growth is fully compensated for.

In another embodiment, web growth is further characterized for the amount of ink or ink density that is applied to the printed stock. This accounts for variances arising when the target image is highly colored and therefore, a larger degree of web growth will occur because of the degree to which the paper is wetted.

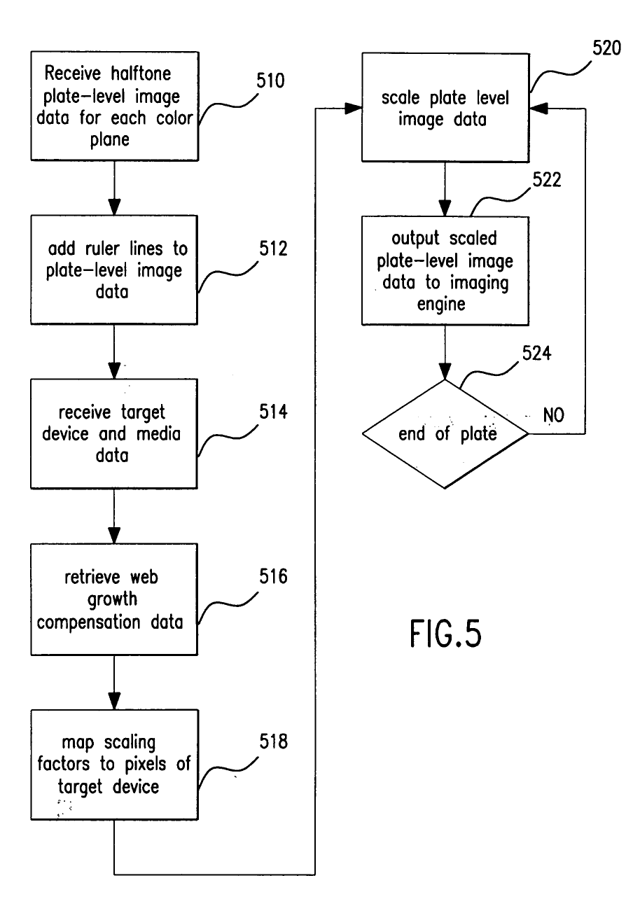

FIG. 5 shows the printing process for the web, using the web growth information, which embodies the principles of the present invention.

Specifically, in step 510, the halftone plate-level image data for each color plane are received by the print driver 16. In one example, a single platesetter/imagesetter, including the driver 16 and the imaging engine 18, produces all of the plates for the printing run. In another example, multiple platesetters/imagesetters 16, 18 are used to generate each of the plates for the color planes. In still another example, the print driver directly controls the exposure of the rollers.

The print driver 16 then adds the grid 410-V, 410-H in step 512. In the preferred embodiment, these grids are the same as that used in the generation of the test image 5-test, see FIGS. 3A and 3B. The grid 410-V, 410-H is added, in the preferred embodiment, to all of the printing runs, along with slug lines and any other additional images to the image data. This allows for the on-going calibration and re-calibration and monitoring of the calibration between the color planes, even during operation, by reference to the grid on the printed web 8.

Then, in step 514, the operator enters the target device or the specific printing press on which the plates 5 are going to be installed. The operator further inputs the target web print media.

In step 516, the print driver 16 accesses the web growth information from Table 2, using the retrieved target device and media data as the look-up criteria. In the preferred embodiment, these are the actual distortion values measured during a previous run or a test run of the web on the specific printing press.

In step 518, the web growth compensation data and, specifically scaling factors, are mapped to the physical pixels of the imaging engine 18. This identifies the actual pixels in the color planes of the plate-level image data that will be operated upon in order to effect the scaling.

With the pixels identified, the plate-level image data are scaled in step 520 and the scaled image data output to the imaging engine in step 522. In the current embodiment, the scaling is performed in real-time during the exposure process in the imaging engine 18. This means that the scaling process must be computationally efficient so that the scaled data are produced at least as quickly as the scaled data are consumed by the imaging engine 18.

The process of scaling and sending the data to the imaging engine in steps 520 and 522 are repeated until the end of the plate or end of the plate-level image data is determined in step 524.

2. Scaling to target device pixels Given a description of how the printing of the various colors distort the web 8 in terms of the printed image, the one bit representation of the color flats can be corrected to eliminate the growth. Two approaches are possible: adjust the subsequent color planes to match the first color (usually scaling up); or scale the color planes flats to match the last color (usually scaling down). In the present embodiment, the approach is to scale the planes to match the last color printed—the reference color, usually yellow or black.

The image data to be scaled are one bit data: it has already been processed by the raster image processor 10 and combined into plate-level data by the imposition system 12. Tinted or degrade regions and image data have been screened. These data will typically have 80 to 150 lines per inch halftone screen applied to them. The other objects, e.g., text, rules and geometric objects are referred to as solids.

The challenge is to change the size of a one bit deep image data without introducing interference patterns in areas containing screened data or reducing the quality and consistency of the solid objects.

According to one embodiment, the scaling is achieved by adding/removing rows and/or columns of the color planes to achieve the desired image size. The problem is, however, that this approach can introduce interference patterns in the screened data and could cause fine rules to disappear or to image with a thickness inconsistent with other rules.

The preferred approach involves the scattering of the row/column to remove or add pixels over a group of rows/columns. For example, the equivalent of a row of pixels is removed in 20-row region. One pixel will be removed from each column, preferably from a stochastically selected row, and the 20 rows will be merged into 19 rows. This approach produces more consistent solids, but can still introduce interference patterns in screened data.

In the present embodiment, knowledge of the characteristics of the halftone screen used by the raster image processor 10, and specifically the size of the halftone dot, is applied to reduce patterns and improve image quality.

In general, the present print driver 16 uses information concerning the halftone screen that was used by the raster image processor 10; it refers to a database of the halftone cell sizes. These data are used by the proofing system 14 to determine the sample area when generating medium resolution 32 bit color proofs from multiple color planes of 1 bit data.

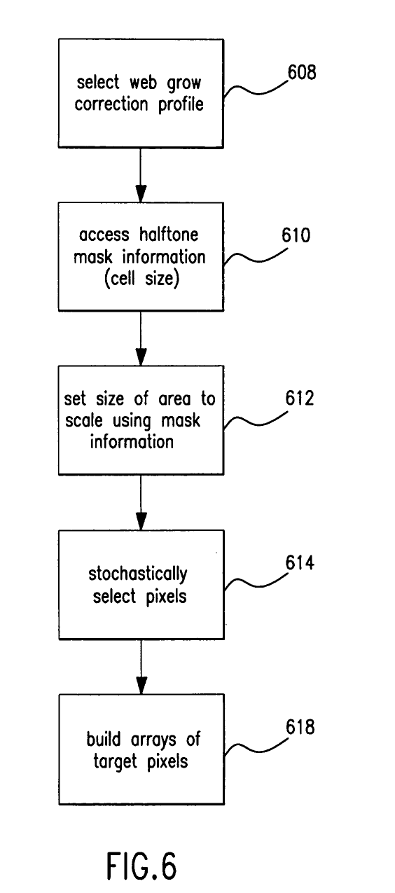

FIG. 6 illustrates the process for scaling the plate-level image data according to the preferred embodiment.

In step 608, a web growth information or correction profile is selected. The information describes the growth measured on the target press when using the target web media. Given the parameters of the plate-level image data, such as width, height, orientation, and resolution, the growth profile describes the web growth information, including positions and growth.

In step 610, the halftone mask information is accessed, specifically the characteristics of masks used to create the plate-level image data. In one example, cell size of the mask applied by the raster image processor 10 is determined. This can be accomplished by interrogating an operator via a user interface. In other examples, the information is stored or received with the plate-level image data.

In step 612, the height of the area to change and thus scale the plate-level image data is set based on the size of a halftone cell. In the present embodiment, the scaling mask is set to be the same as the halftone cell size, e.g. 16 pixel by 16 pixel region. In the typical case, 16 rows of pixels will reduce to 15 rows of pixels, but in some cases the 16 starting rows will grow to 17. Thus, the average gray level remains generally constant. Solids should have only some resulting patterns.

In step 614, the target pixels are selected in the scaling mask. This confines the stochastic row selection to a cell size by cell size area. That is, in every 16 columns, each row will gain/lose one (and only one) pixel. Each scaling mask of 16×16 pixels has a stochastically generated selection of rows for each column.

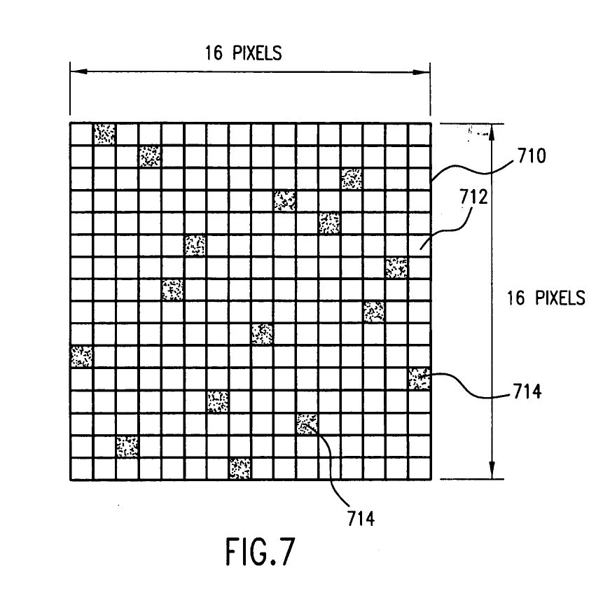

FIG. 7 shows an exemplary scaling mask or grid 710. It comprises 16 rows and 16 columns of pixels 712 that are mapped to the plate-level image data. Of the pixels, 16 target pixels 714 are identified. They have a stochastic distribution, but a unique column and row.

The similar scaling masks are created and applied over a wider area of the plate-level image data. In one example, the 16×16 scaling masks, such as mask 710 but having individually-generated pixel selections, are applied over 25 (400/16) 16 pixel wide columns. However, in the present embodiment, the width is capped at 200 pixels (or 12 16-pixel width columns in 192 columns) to reduce the distortion introduced by scaling. In short, the 16×16 pixel scaling masks are stochastically generated and then the masks stochastically placed.

The stochastic distribution of the present embodiment reduces patterns, but some still appear. Thus, in other embodiments, especially where the amount of reduction is small (typically less than 1.0%), the height of the area to reduce is expanded. For 0.1% case, for example, there is a need to duplicate/remove 1 out of every 1000 pixels, or merge 1000 rows to get 1001 or 999.

Stochastically selecting one of the 1000 rows for each column eliminates the interference patterns. The solids, especially the thinner ones, get distorted. A 1-pixel shift can be seen from row to row. Straight edges seem to grow “hairy” (at least stubbly).

Returning to FIG. 6, in step 618, two arrays are built containing the set of target pixels 714 and scale directions (up/down). The directions and coordinates in the correction profile are relative to the leading edge of printed sheet: they are mapped to image space, upper left being (0,0) and lower right being (width-1, height-1). The resulting horizontal arrays are combined to form one array describing the image from left to right. The resulting vertical arrays are combined to one array describing the image from top to bottom.

Should the dimensions of the output media be different from the position ordinates in the correction profile, the appropriate position/growth ordinates are preferably interpolated or extrapolated to match the media dimensions.

The two arrays would then be combined into one array from west to east:

The growth values for each position are changed to be relative to each zone. A similar transformation is done for the north/south coordinates. The target pixel positions are calculated by: determining the number of pixels to add/delete for each position/growth pair; and dividing the width of that region equally among the pixel to affect. For example, converting to image pixels at 2400 dots per inch, the following growth values are generated in one example:

0, 0

24000, 96

48000, 120

67200, 96

96000, 96

This means that: 96 of the 24000 pixels (0 to 23999) or one of 250 pixels must be deleted; 120 of the 24000 pixels (24000 to 47999) or one of 200 pixels is deleted; 96 of the 19200 pixels (48000 to 67199) or one of 200 pixels is deleted; and 96 of the 28800 pixels (67200 to 95999) or one of 300 pixels is deleted.

A targetPixel array containing numDelta=432 target pixel positions (and scale direction) is generated from these data (250, 500, . . . , 24000, 24200, . . . ). It will be necessary to track fractional pixels and adjust the target position if the zone width is not evenly divisible by the number of target pixels.

The minimum pixel span (in this case 200) and the halftone dot size will be used to generate an array of stochastic offsets' from these pixel positions. For example, a 150 line screen at 2400 dpi yields a halftone dot size of 16-pixels. A minimum span of 200 pixels allows for 12 16-pixel wide cells, which will occupy 192 pixels.

The length of the array of offsets will be a multiple of the halftone cell size (e.g. 128*16=2048). The contents of each cell are determined as:

```
#define ARRAYMULTIPLE 128
int shuffledValues[dotSize]
int offsetArray[ARRAYMULTIPLE * dotSize];
int numCells = minPixelSpan / dotSize;
for (i = 0; i < ARRAYMULTIPLE; i++)
{
    int cellOffset = dotSize * rand(numCells);
    GetShuffledValues(dotSize, shuffledValues);
    for (j = 0; j < dotSize; j++)
    {
        offsetArray[i* dotSize + j] = shuffledValues[j] +
cellOffset;
    }
}
```

where rand(intNum) returns a pseudo random value from 0 to intNum−1, and GetShuffledValues(intNum, array) fills array with the pseudo randomized values of 0 to intNum−1. The offset array contains offsets to apply to the target pixel array. The values are generated so each group of dotSize entries identifies a pixel within the same halftone dot area, and that the dotSize pixels are in different rows/colums of the dotSize area.

By combining the target pixel and offset arrays, a two dimensional array of pixels (and scale directions) to delete (or duplicate) is generated.

```
for (x = 0; x < numDelta; x++)
{
    for (y = 0; y < ARRAYMULTIPLE * dotSize; y++)
    {
        // pixel to affect
        pixelPos [x][y].pos = targetArray[x].pos -
offsetArray[y];
        // delete or duplicate
        pixelPos[x][y].dir = targetArray[x].dir;
    }
}
```

3. Scaling Horizontally on-the-Fly

To change the width of the image, it is required to delete or duplicate specific pixels for each row. To do this on the fly it is required to further simplify the data. As adjustments to the image are mainly shifting the data and occasionally deleting or duplicating a pixel, the pixelPos array is distilled into a list of commands for a shifting engine.

The shift commands contain a header with count of excess pixel at the start of line (padding for lines with more deleted than duplicated pixel; pixel clip count for the converse) and a trailer to flag the end of the row. The pixelPos values will be broken into zones (areas of pixel deletion and areas of pixel duplication). A zone header specifies the scale direction (delete or duplicate) and initial shift count. It is followed by pairs of values: the first containing the number of longs (32 bit groups of image data) to shift and copy; and the second the offset to the pixel in the next shifted long to delete or duplicate. The final entry in a zone is a trailer, which notifies the shifting engine to look for the next zone header or list's end of row trailer.

In the present embodiment, the shift engine is written in Intel assembler and uses the following macro to load source image data, shift the image data “s” locations (0 to 31), store the shifted image, and load and shift the data containing the pixel to delete or duplicate.

```
// eax:edx contain next 0-63 pixels of image data
// ebx-> long count / pixel offset
// esi->source image, edi->output image
// arg “s” is the number of pixels to shift, “dir” is Del(ete)
or Dup(licate)
#define ShiftAndCopy32(s,dir)
ShiftAndCopy32_##Dir:
    mov curShift,s
    mov ecx, [ebx]ShiftCmds.dirCnt
    add ebx, 8
    jcxz ShiftAndCopy_32_1
ShiftAndCopy_32_0_##Dir:
    shrd eax, edx, s
    stos eax
    lods eax
    xchg eax, edx
    loop ShiftAndCopy_32_0_##Dir
ShiftAndCopy_32_1:
    mov ecx, [ebx-4]ShiftCmds.pix
    shrd eax, edx, s
```

The code to delete pixels makes use of the ShiftAndCopy macro, then loads the pixel offset (−1 flags end of zone), isolates and removes the pixel, fills the vacant 32^{nd} pixel from the next pixel in source image.

| #define SHIFT_AND_COPY_32_DEL(s) | |
|---|---|
| SHIFT_AND_COPY_32(s,Del) | |
| test ecx, ecx | |
| js ScaleRowNextZone | |
| rcr eax, 1 | |
| rcr eax, cl | |
| rol eax, 1 | |
| rol eax, cl | |
| shr edx, s | |
| shrd eax, edx, 1 | |
| stos eax | |
| add esi, 4 | |
| mov | eax, [esi-8] |
| mov | edx, [esi-4] |

The code to duplicate pixels makes use of the ShiftAndCopy macro, then loads the pixel offset (−1 flags end of zone), isolates and duplicates the pixel, the original 32^{nd} pixel will be reloaded for the next set of copy/pixel offset commands.

| #define SHIFT_AND_COPY_32_DUP(s) | |
|---|---|
| SHIFT_AND_COPY_32(s,Dup) | |
| test ecx, ecx | |
| js ScaleRowNextZone | |
| ror | eax, 1 |
| ror | eax, cl |
| rcl | eax, 2 |
| rcl | eax, cl |
| stos | eax |
| add | esi, 4 |
| mov | eax, [esi-8] |
| mov | edx, [esi-4] |

As pixels are deleted the shift count will increase by 1; as pixels are duplicated the shift count will decrease by 1. By stringing together a series of macro calls, adjusting for shifting into/from a new 32-bit field, and handling the end of zone trailer, the required shifting engine is defined.

| ResetShiftCount Del: | | |
|---|---|---|
| SHIFT_AND_COPY_32_DEL( 0); | | |
| SHIFT_AND_COPY_32_DEL( 1); | | |
| . | | |
| . | | |
| . | | |
| SHIFT_AND_COPY_32_DEL(31); | | |
| // adjust for lost 32 bits of input after shifting 31 + 1 | | |
| _asm | mov | eax, edx |
| _asm | mov | edx, [esi] |
| _asm | add | esi, 4 |
| goto ResetShiftCountDel; | | |
| ResetShiftCountDup: | | |
| SHIFT_AND_COPY_32_DUP(31); | | |
| SHIFT_AND_COPY_32_DUP(30); | | |
| . | | |
| . | | |
| . | | |
| SHIFT_AND_COPY_32_DUP( 0); | | |
| // adjust for b31 which we still need for next 32 bits | | |
| _asm | sub | esi, 4 |
| _asm | mov | eax, [esi-8] |
| _asm | mov | edx, [esi-4] |

| goto ResetShiftCountDup; | |
|---|---|
| ScaleRowNext Zone: | |
| // get scale direction; 0 = scale down, 1 = scale up, < 0 = | |
| done | |
| mov | ecx, [ebx]ShiftCmds.dirCnt |
| add | ebx, TYPE ShiftCmds |
| test ecx, | ecx |
| js | ScaleRow_Done |
| // set up vector 0/1 -> 0/32; 0-31 scale down, 32-63 scale | |
| up | |
| shl | ecx, 5 |
| // add in amount to shift | |
| add | ecx, curShift |
| // convert to byte offset into a table of 32 bit addresses | |
| shl | ecx, 2 |
| // add in base of table | |
| add | ecx, vectorTable |
| mov | ecx, [ecx] |
| // go to it | |
| jmp | ecx |

Other processing required includes padding the start and end of the output image as needed and mapping the source row index to an index into the array of shift commands.

4. Scaling Vertically On-The-Fly

The process for creating the pixelPos needs to be repeated for vertical scaling, which is implemented as described previously by replacing rows/columns.

To change the height of the image, it is required to delete or duplicate specific pixels for each column. To do this on the fly we need to further simplify the data. As adjustments to the image are mainly shifting the data and occasionally deleting of duplicating a pixel, the offsetArray is distilled into an array of mask rows.

A maskArray consists of (minPixelSpan/dotSize)*dotSize rows, each row containing ARRAYMULTIPLE*dotSize pixels. The maskArray will be initialized to 0s. The value in the offsetArray will be the row index into the maskArray; the index into the offsetArray will be the pixel index into a row of the maskarray. All maskArray pixels identified from the offsetArray will be set to 1s. The rows of the maskArray are then sequentially ORed together (i.e. . . . , row[i+1]=row[i]|row[i+1], row[i+2]=row[i+1]|row[i+2], . . . ). So for any given row, i, of the maskArray the pixels of interest for rows 0 to i will be set to 1s. A targetRow array (similar to targetPixel array) will identify the beginning of a set of rows to affect. Any source image row that is not part of a mergeRange (targetArray[i] to targetArray[i]+(minPixelSpan/dotSize)*dotSize−1) is copied from the source image to the output image.

A mergeRange that requires the deletion of a row will logically OR the contents of:

SourceRow[i] & ˜maskArray[i %+((minPixelSpan/dotSize)*dotSize)] and

SourceRow[i+1] & maskArray[i %+((minPixelSpan/dotSize)*dotSize)] to create ouputRow[i].

This is done for each output row. As we advance through the bytes of source rows and the maskArray, we must reset the maskArray's byte index when it exceeds ARRAYMULTIPLE*dotSize/8 pixels.

A mergeRange that requires the duplication of a row will: 1) copy the first source row of the mergeRange; 2) logically OR the contents as follows:

SourceRow[i] & maskArray[i %+((minPixelSpan/dotSize)*dotSize)] and

SourceRow[i+1] & ˜maskArray[i %+((minPixelSpan/dotSize)*dotSize)] to create ouputRow[i];

3) copy the last source row of the merge range.

This is done for each output row. As we advance through the bytes of source rows and the maskArray, we must reset the maskArray's byte index when it exceeds ARRAYMULTIPLE*dotSize/8 pixels.

NOTE: the logical combination of source and maskArray rows is best done in Intel Assembler with the MMX instruction set (64-bit operations). Also, additional processing will include padding the top and bottom of the output image.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for exposing offset printing media with image data that have to be scaled to compensate for web growth, the system comprising:
an imaging engine for exposing the offset printing media in response to scaled image data; and
a print drive system that receives plate-level image data and generates the scaled image data to the imaging engine in response to web growth information.

2. A system as claimed in claim 1, wherein the offset printing media is film that is used to make printing plates for a web printing press.

3. A system as claimed in claim 1, wherein the offset print media are printing plates or rollers for a web printing press.

4. A system as claimed in claim 1, further comprising an imposition system that generates the plate-level image data by combining page-level image data of several pages.

5. A system as claimed in claim 4, further comprising a raster image processor that halftones page-level images into the page-level image data for each color plane.

6. A system as claimed in claim 1, wherein the print drive system generates the scaled image data during a transfer of the scaled image data to the imaging engine.

7. A system as claimed in claim 1, wherein the print drive system generates the scaled image data by adding pixels to and/or removing pixels from the plate-level image data.

8. A system as claimed in claim 7, wherein in the added or removed pixels are stochastically distributed between rows or columns.

9. A method for exposing offset printing media with image data that have to be scaled to compensate for web growth, the method comprising:
generating the scaled image data to the imaging engine in response to web growth information and plate-level image data; and
exposing the offset printing media in response to scaled image data.

10. A method as claimed in claim 9, wherein the offset printing media is film that is used to make printing plates for a web printing press.

11. A method as claimed in claim 9, wherein the offset print media are printing plates or rollers for a web printing press.

12. A method as claimed in claim 9, further comprising generating the plate-level image data by combining page-level image data of several pages.

13. A method as claimed in claim 12, further comprising halftoning page-level images into the page-level image data for each color plane.

14. A method as claimed in claim 9, further comprising generating the scaled image data during a transfer of the scaled image data to an imaging engine.

15. A method as claimed in claim 9, further comprising generating the scaled image data by adding pixels to and/or removing pixels from the plate-level image data.

16. A method as claimed in claim 15, further comprising adding and/or removing pixels stochastically distributed between rows or columns.

17. A web printed image, comprising:
areas corresponding to page-level image data; and
indicia for assessing web growth.

18. A web printed image as claimed in claim 17, wherein the areas corresponding to page-level image data comprise production images.

19. A web printed image as claimed in claim 17, wherein the indicia comprises a grid.

20. A web printed image as claimed in claim 19, wherein the grid is centered between the page-level image data.

21. A web printed image as claimed in claim 19, wherein the grid extends from a center in four directions.

22. A web printed image as claimed in claim 19, wherein the grid is added after application of web growth compensation.

23. A method for compensating for web growth, the method comprising:
characterizing web growth by measuring web growth at multiple places on a web; and
compensating for the web growth by scaling plate-level image data in response to the measured web growth.

24. A method as claimed in claim 23, wherein the web growth is measured at multiple distances from a center of printed image on the web.

25. A method as claimed in claim 23, wherein the web growth is measured by printing a grid in each color and measuring distortion between the colors.
